(19) United States
(12) Patent Application Publication
(10) Pub. No.: US 2020/0094509 A1
(43) Pub. Date: Mar. 26, 2020

(54) Method for Manufacturing Fibrous Paper-plastic Disc-shaped Product

(71) Applicant: Changzhou CIty Cheng Xin Environmental Protection Technology Co., Ltd., Jiangsu Province (CN)

(72) Inventor: Tzung-Shen Lai, Yilan CIty (TW)

(21) Appl. No.: 16/137,787

(22) Filed: Sep. 21, 2018

(51) Int. Cl. B31B 50/59; B31B 50/04; B31B 50/20; B31B 50/74

(52) U.S. Cl. CPC B31B 50/59; B31B 50/042; A47G 19/02; B31B 50/742; B31B 50/20

(57) ABSTRACT

In a method for manufacturing a fibrous paper-plastic disc-shaped product, a pulp sheet is prepared, sent to a cutting machine, and cut into a primitive sheet. The primitive sheet is formed by at least one primitive material for manufacturing a desired fibrous product and has a surface coated with a solution containing an additive. The primitive sheet is set still to achieve an osmotic balance inside the primitive sheet, and passed through a hot-press machine for hot pressing to press and dry the primitive sheet into a dry molded plate. Each primitive material of the original primitive sheet is pressed into a shape of the desired fibrous product to form a dry molded product. Finally, the dry molded plate is sent to a trimming machine for trimming and cutting, so that each dry molded product on the dry molded plate is formed into the fibrous product.

### BACKGROUND OF THE INVENTION

### Field of the Invention

The present invention relates to a method for manufacturing a fibrous paper-plastic disc-shaped product, and more particularly to the method for manufacturing a fibrous paper-plastic disc-shaped product with a relatively larger side-skewed angle and a relatively smaller (or shallower) depth.

### Description of the Related Art

Plastic products made of a plastic material generally have the issues of releasing toxins and causing serious pollutions to the environment, the difficulty of reusing, recycling, decomposing or processing the plastic product, and incurring a huge expense for processing the plastic product, and thus the plastic products have made serious damages to the global environmental protection for years. In the era of today's high awareness on environmental awareness, the search for non-toxic and easily recycled materials has become a mainstream of research and practical applications.

At present, paper pulp fiber materials and/or plant fiber materials are mixed and pulped to form a pulp material, and a suction mold is provided for sucking and attaching a slurry, and the pulp material is hot-pressed and molded into a product which is generally called a “molded product” to distinguish it from the plastic product. The molded product has the advantages of giving an easy way for recycle and reuse and complying with the trend of environmental protection, reuse, energy-saving and carbon reduction. Therefore, the molded product quickly becomes popular in the business community and the general public. The common molded products include products such as bowls, plates, lids, packaging materials, shock absorbers, pads, etc.

With reference to FIG. 1 for a manufacturing method of a conventional molded product, the manufacturing method comprises the following steps:

Beating: This is a rough disintegration step carried out by putting the collected paper pulp fiber materials and/or plant fiber materials into a beater and disintegrating the materials with water. Recently, the paper pulp fiber materials and/or plant fiber materials are solidified first to produce a flaky pulp sheet with a specific area to facilitate the storage and transportation, so that the beating step is a step of putting the pulp sheet into the beater and disintegrate the pulp sheet with water.

Refining: This is a step of sending the material beaten and disintegrated with water into a miller, and milling and refining the material to produce a concentrated slurry with finer fibers.

Pulping: This is a step of adding an appropriate additive and diluting the additive with water to an appropriate slurry proportion, so as to form a slurry.

Filling into a slurry tank: This is a step of storing the slurry into a slurry tank, and pumping the slurry to a suction tank by a pump for a repeated use.

Forming into a wet primitive material: This is a step of sucking the slurry by a suction system, and forming a wet primitive material in a mold.

Hot pressing to form a dry molded product: This is the step of sending the wet primitive material into a hot-pressing mold, heating and pressurizing the wet primitive material to dry and mold the wet primitive material into a dry molded product.

Renovating into a finished product of the molded product: This is a step of sending the dry molded product to a trimming machine for trimming the edge and forming a finished product of the molded product in the expected shape.

In the whole manufacturing process, the material (such as pulp sheet) is beaten, refined, pulped, and delivered to a slurry tank, and such system is a pulping system, and then a suction setting and a hot-press setting are combined to form a molding system, and finally, the material is trimmed, and such system is a trimming system. In present conventional manufacturing technologies, a slurry is used to manufacture a molded product, and pulping system, molding system and trimming system are necessary systems for the manufacture.

In view of the following drawbacks of the conventional manufacturing method for the molded product, the inventor of the present invention based on years of experience in the related industry to conduct extensive research and experiment and finally provide a novel manufacturing method for the molded product to overcome the drawbacks of the prior art.

High equipment cost: The manufacturing equipment required by the conventional method for manufacturing a molded product must include a conveying pipeline, a vacuum system and equipment, a suction pipeline, a pulp beater, a pulper, a pulp preparer, a slurry tank, a transfer pump and a valve, and incurs the manufacturing costs for various different molding molds and hot-pressing molds.

Huge power consumption: The conventional method for manufacturing a molded product incurs the operation costs for the beating, refining, pulping, and different manufacturing operations from the slurry tank to the suction tank and fluid delivery and requires a large amount of energy to heat and dry the wet primitive material, wherein the hot-pressing time generally takes 90˜120 seconds, so that the process consumes a large quantity of water, and a large quantity of energy for drying the wet primitive material. Obviously, the cost for the whole consumption of water and electricity is huge.

Large installation space: The conventional method for manufacturing a molded product requires a pulping system comprising a conveying pipeline, a vacuum system and equipment, a suction pipeline, a pulp beater, a pulper, a pulp preparer, a slurry tank, a transfer pump, a valve, etc. and also needs a huge area or space to accommodate them, and thus incurring high investment cost and manufacturing cost.

Environmental concerns: The conventional method for manufacturing a molded product uses clear water for repeated slurry and suction settings in the pulping system, and thus wastewater will be produced, so that it is necessary to install a wastewater processing device or wastewater recycle system, and such installation cost will increase the investment and manufacturing costs, and the process for processing the wastewater also has an environmental concern.

Limited working hour and production capacity: The conventional method for manufacturing a molded product has a major bottleneck on the length of the working hour of the hot-press setting step. Since the conventional method produces a wet primitive material which sometimes contains a large amount of aqueous solution, therefore the hot-pressing time cannot skipped, and both of the working hour and the production capacity are limited greatly.

If the molded product has a larger manufacturing size (such as higher and/or thicker shock absorbing material or pad material) or a more complicated stylish shape (such as the packaging material capable of accommodating more units) or a higher depth (such as a deep bowl), the suction setting and hot-pressing molding time will become longer, so that the manufacturing method of the invention can be adopted for an appropriate manufacture due to its convenience and high yield of the final product , and the environmental advantages of the product are superior to the aforementioned drawbacks. Obviously, the manufacturing method of the invention is a very good method.

When it is necessary to manufacture a product with a small (shallow) depth (such as a shallow plate), both of the material used for suction and the working hour are relatively less, so that the conventional method for manufacturing a molded product causes inconvenience and unnecessary waste. The manufacture of the products with a small (shallow) depth requires an appropriate manufacturing method to overcome the drawbacks of the conventional method.

### SUMMARY OF THE INVENTION

Therefore, it is a primary objective of the present invention to provide a method for manufacturing a fibrous paper-plastic disc-shaped product specially applicable for manufacturing a product with a relatively large side-skewed angle and a relatively small (or shallow) depth.

Another objective of the present invention is to provide a method for manufacturing a fibrous paper-plastic disc-shaped product capable of lowering equipment costs, reducing power consumption, saving equipment installation space, having environmental advantages, shortening working hour, increasing production capacity, and improving product quality and strength significantly.

To achieve the above mentioned objective, the present invention is to provide a method for manufacturing a fibrous paper-plastic disc-shaped product, comprising the steps of:
(1) conveying a flat flaky pulp sheet to a cutting machine to cut the pulp sheet into a primitive sheet, wherein the primitive sheet is formed by at least one primitive material for manufacturing a desired fibrous product;
(2) coating a solution containing an additive onto a surface of the primitive sheet;
(3) sending the primitive sheet processed with the coating to a hot-press machine, and heating and pressurizing the primitive sheet by the hot-press machine, so that the primitive sheet is pressed and dried into a dry molded plate, and each original primitive material is pressed into a shape of the desired fibrous product to form a dry molded product; and
(4) sending the dry molded plate to a trimming machine for trimming and cutting the dry molded plate according to the size of the fibrous product, so as to form the fibrous product from the original dry molded product.

According to the above mentioned method for manufacturing a fibrous paper-plastic disc-shaped product, the primitive sheet processed with the coating is set still, so that the solution received by the primitive sheet is further mixed and permeated into the primitive sheet uniformly to achieve an osmotic balance effect, and then the primitive sheet processed with the static balance is sent to the hot-press machine.

According to the method for manufacturing a fibrous paper-plastic disc-shaped product, the pulp sheet is conveyed by a first conveyor, so that the pulp sheets are entered into the cutting machine sequentially

According to the method for manufacturing a fibrous paper-plastic disc-shaped product, the primitive sheet processed with the coating is conveyed by a second conveyor.

### BRIEF DESCRIPTION OF THE DRAWINGS

FIG. 1 is a block diagram of a manufacturing procedure of a conventional method for manufacturing a molded product;

FIG. 2 is a block diagram showing the flow of a first manufacturing procedure of the present invention;

FIG. 3 is a schematic view of a front mechanism of the first manufacturing procedure of the present invention;

FIG. 4 is a schematic view of a rear mechanism of the first manufacturing procedure of the present invention;

FIG. 5 is a schematic view showing various different ways of coating used in the manufacturing procedure of the present invention;

FIG. 6 is a schematic view of a primitive sheet of the present invention;

FIG. 7 is a schematic view of a fibrous product of the present invention;

FIG. 8 is a block diagram showing the flow of a second manufacturing procedure of the present invention; and

FIG. 9 is a schematic view of the mechanism of the second manufacturing procedure of the present invention.

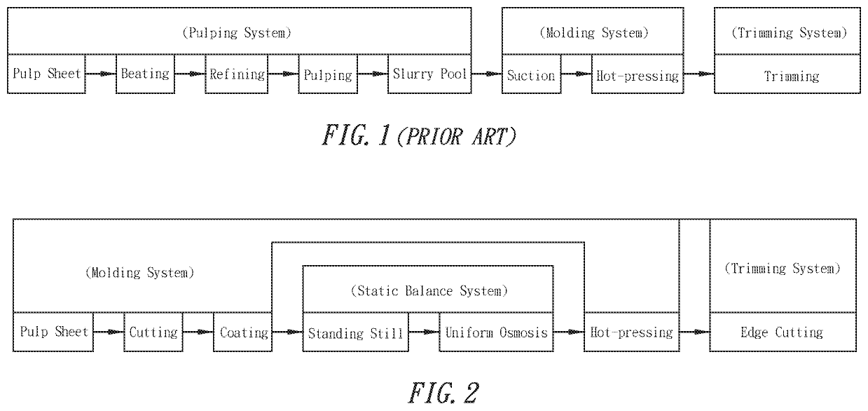

### DETAILED DESCRIPTION OF THE PREFERRED EMBODIMENTS

The technical characteristics, contents, advantages and effects of the present invention will be apparent with the detailed description of a preferred embodiment accompanied with related drawings as follows.

The present invention discloses a method for manufacturing a fibrous paper-plastic disc-shaped product, particularly the manufacturing applicable for manufacturing a fibrous product with a relatively large side-skewed angle and a relatively small (or shallow) depth. The fibrous product with a “relatively large side-skewed angle and a relatively small (or shallow) depth refers to something like a “shallow plate” which is a typical example for the large side-skewed angle and small (or shallow) depth, and the “fibrous product” refers to a finished product made of a raw material formed by mixing paper pulp fiber materials and/or plant fiber material and manufactured by the manufacturing method of the present invention, wherein such product is the fibrous paper-plastic disc-shaped product of the present invention. Since the manufacturing method of the present invention does not use the suction setting technology, therefore the product is also called a “fibrous product” or “fibrous paper-plastic disc-shaped product” to be distinguished from the “plastic product” and “molded product”. Before the manufacture, the present invention prepares a material by using a “pulp sheet” as an initial material. The “pulp sheet” refers to a raw material formed by mixing paper pulp fiber materials and/or plant fiber materials and going through the manufacturing and consolidation processes to form a flat pulp sheet with a specific area to facilitate the storage and transportation. When the pulp sheet is solidified, the dimensions (including the length, width, and height) of the pulp sheet may be selected. Since the pulp sheet is used as a further manufacturing material, therefore it is not completely dry when being solidified, but the pulp sheet is a material with a relatively low wetness.

With reference to FIGS. 2 to 5 for the manufacturing method of the present invention, the pulp sheet 1 is used as the initial material and then process according to the following manufacturing procedure:

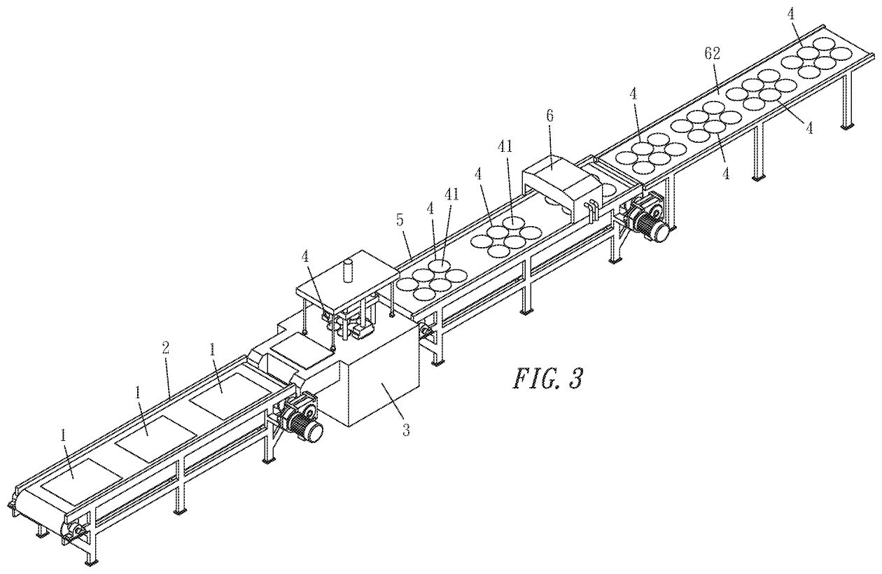

In FIGS. 2 and 3, a first conveyor 2 is provided for conveying the flat flaky pulp sheets 1 to move forward one by one, so that the pulp sheets 1 enter into a cutting machine 3 sequentially, and the cutting machine 3 directly cuts the pulp sheet 1 into a primitive sheet 4 according to a pressing and trimming size which is slightly larger than the size including the length and width of the desired fibrous product. In FIG. 6, the primitive sheet 4 is formed by at least one primitive material 41, and the size of the primitive material 41 is slightly larger than the size of the final desired fibrous product, wherein this pattern is expressed by six primitive materials 41, but the invention is not limited by such arrangement only. It is noteworthy that if the primitive sheet 4 includes a plurality of primitive materials 41, then the adjacent primitive materials 41 may be disconnected or connected, wherein the term “disconnected” refers to the adjacent primitive materials 41 have been cut by the cutting machine 3, but all primitive materials 41 are still collected and combined into a flat primitive sheet 4; and the term “connected” refers to the adjacent primitive materials 41 are connected with each other with a minimum contact, and the remaining parts have been cut and removed by the cutting machine 3.

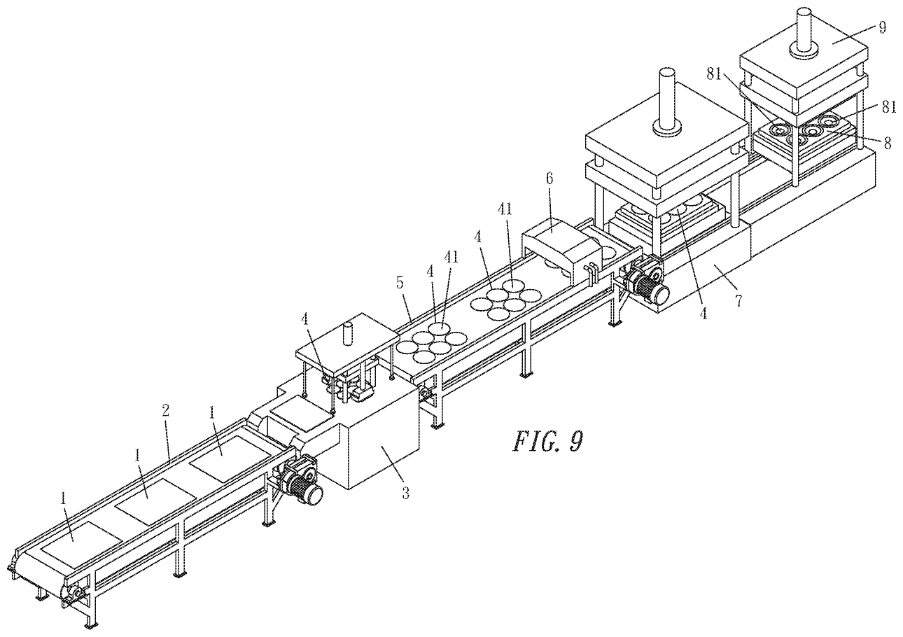

The primitive sheet 4 is sent to a second conveyor 5 and moved forward. During the process, a solution containing an additive is coated onto a surface of the primitive sheet 4 as shown in FIG. 5, wherein the “coating” refers to a solution containing an additive is processed by a manual operation or a mechanical operation such as a spray coating operation, a brush coating operation, or a dip coating operation, so that the solution containing an additive is adhered onto a surface of the primitive sheet 4. Specifically, the “coating” refers to by a manual spray coating (such as manual gun-spraying coating) or a mechanical spray coating (such as automatic spray coating by a spraying machine), or it may be a manual brush coating (such as manual brush coating by brushes) or a mechanical brush coating (such as automated brush coating by rollers), or it may be a manual dip coating (such as manual setting or removing dip coating) or a mechanical dip coating such as a pass-through dip coating). In short, any operation capable of sticking the solution containing an additive onto a surface of the primitive sheet 4 is referred to as “coating”. In FIG. 3, the second conveyor 5 includes a spraying machine 6, and when the primitive sheet 4 conveyed by the second conveyor 5 is passed through the spraying machine 6, the spraying machine 6 will spray the solution containing an additive upwardly onto the surface of the primitive sheet 4. The most basic role of the surface of the primitive sheet 4 receiving the solution containing an additive is to seal the surface of the primitive sheet 4, so that the primitive sheet 4 has the waterproof and oil-proof effects. In addition, the coating may be a solution containing different (special) additives depending on the requirements of the use and function of the desired fibrous product. It is noteworthy that the coating operation of the primitive sheet 4 may be applied to the top surface of the primitive sheet 4 as shown in FIGS. 3 and 9, wherein the solution is sprayed onto the top surface of the primitive sheet 4), or the coating operation may be applied selectively to the bottom surface of the primitive sheet 4, if needed.

The primitive sheet 4 processed with the coating operation may be sent to a standing stable 62 and set still, so that the solution received by each primitive sheet 4 can be further permeated into the interior uniformly to achieve an osmotic balance effect, wherein the standing time of the primitive sheet 4 depends on the size of the object, and the primitive sheets 4 may stand still in a scattered flat fashion (if the space allows) or a stacked manner (if the space is insufficient for the scattered flat fashion), and the step of such “static balance” may be carried out selectively, and the details will be described below.

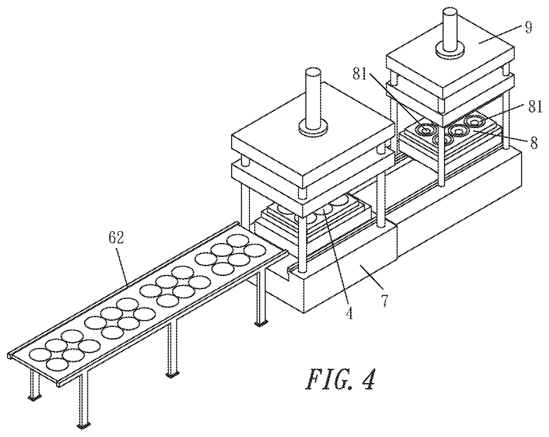

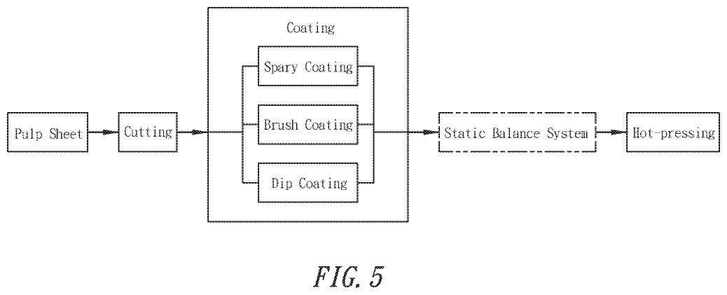

In FIGS. 2 and 4, the statically balanced primitive sheets 4 are sent to a hot-press machine 7, wherein the hot-press machine 7 directly heats and pressurizes the primitive sheets 4, so that the primitive sheets 4 are pressed and dried and molded into a dry molded plate 8. During the process, each original primitive material 41 is pressed into a stylish shape of the desired fibrous product, but there is a remaining material remained at the top periphery of the fibrous product. In other words, after the primitive sheets are pressed and dried by the hot-press machine 7, each original flat primitive material 41 has been pressed to produce a dry molded product 81 in a three-dimensional shape with the expected depth and side-skewed angle, but there is still a little remaining material at the top periphery, because the humidity is now close to zero humidity, so that the whole semi-product is called a dry molded plate 8.

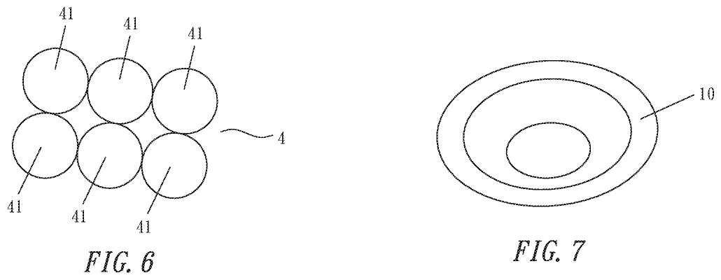

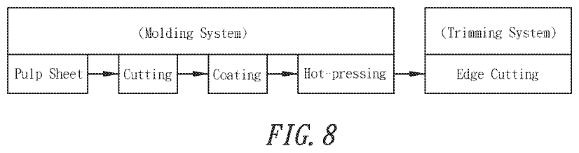

The dry molded plate 8 is sent to a trimming machine 9, and the remaining material of each dry molded product 81 is trimmed and cut. In other words, the remaining material is removed according to the external periphery or length and width of the desired fibrous product, so that the original dry molded products 81 are formed into independent fibrous products 10 (such as the shallow plates) one by one as shown in FIG. 7.

In the aforementioned manufacturing procedure of the present invention, if the final fibrous product is a thin object, the solution may reach the osmotic balance easily and quickly after the roll-pressing process, so that the static balance system as shown in FIG. 2 may be omitted selectively. Now, the first conveyor 2 conveys the flat flaky pulp sheets 1 to the cutting machine 3 sequentially to cut the pulp sheets 1 into primitive sheets 4 as shown in FIGS. 8 and 9, and then the second conveyor 5 conveys the primitive sheets 4 to move forward. During the process, the solution sprayed by the spraying machine 6 (which is a coating operation) contains an additive; and then the primitive sheets 4 are heated and pressurized by the hot-press machine 7, so that the primitive sheets 4 are pressed and dried to form the dry molded plates 8. After the dry molded plates 8 are trimmed by the trimming machine 9, the expected fibrous products 10 are manufactured.

In the aforementioned procedure of the manufacturing method of the present invention, the automated delivery of the pulp sheets 1 to the cutting machine 3 may be completed by the first conveyor 2. In other words, the pulp sheets 1 are manually sent to the cutting machine 3 one by one to complete the same action. Similarly, the primitive sheets 4 processed by the automated delivery of coating (such as being sprayed by the spraying machine 6) may be completed by the second conveyor 5. In other words, the primitive sheets 4 are manually sent one by one to complete the same action. Of course, if it is necessary to move the primitive sheets 4 to the standing stable 62 after the primitive sheets 4 are coated, then the removal may be completed manually or automatically (by a machine). Finally, the action of sending the primitive sheets 4 processed by pressing or static balance to the hot-press machine 7 may be completed manually or automatically (by a machine).

In view of the description above, the present invention skips the preparation of the conventional pulping system and directly carries out the work of the molding system, the static balance system and the trimming system. In the working process of the molding system, the operation of suction plastic molding is no longer needed, and the materials are directly spread out, cut and coated, and then a hot-press operation is carried out after the static balance, and finally the trimming operation is carried out to produce the expected fibrous product of the present invention. The manufactured is definitely very convenient.

Compared with the conventional method for manufacturing a molded product, the present invention has the following advantages regardless of including or excluding the procedure of the “static balance system.

Saving equipment costs: The whole process of the method for manufacturing a fibrous paper-plastic disc-shaped product in accordance with the present invention simply comprises the steps of conveying the pulp sheets, cutting the pulp sheets into primitive sheets, coating a solution containing an additive, directly hot-press molding, and trimming the edges, so that the invention omits the conveying pipeline, vacuum system and equipment, suction pipeline, pulp beater, pulper, pulp preparer, slurry tank, transfer pump and valve required by the conventional method for manufacturing a molded product and lowers the mold cost, so that both equipment and manufacturing costs can be reduced significantly.

Saving energy: The method for manufacturing a fibrous paper-plastic disc-shaped product of the present invention directly uses the pulp sheets as the manufacturing material, and directly enters into the hot-press process without requiring the preparation of a complicated pulping system or the operation of suction molding operation, so that as to save the operation costs for beating, refining, pulping, and different manufacturing operations from the slurry tank to the suction tank and fluid delivery. During the process of the hot-press machine of the present invention, the requirement for dry humidity is not too strict, and the main effect resides on heating and pressing the primitive sheets into the dry molded plates, so that the heating time is not too long (generally falling within a range of 5˜15 seconds depending on the size of the product), so that the power consumption can be reduced significantly. In general, the power consumption of the present invention is approximately one-tenth of that of the conventional method for manufacturing a molded product.

Saving equipment installation space: The method for manufacturing a fibrous paper-plastic disc-shaped product of the present invention directly uses the procedure of cutting the material and the coating operation to replace the conventional complicated pulping and suction molding processes, so as to save a huge pulping system installation area (including the installation areas of a conveying pipeline, a vacuum system, a beater, a pulper, a pulping pool, a slurry tank, etc.). As a result, the installation space of the whole production line can be reduced significantly.

Having environmental advantages: The method for manufacturing a fibrous paper-plastic disc-shaped product of the present invention requires no pulping system, slurry conveying loop pipeline, etc. in the manufacturing process, so that there is no environmental issue of producing or processing wastewater at all. Shortening working hour and improving production capacity significantly: In the manufacturing process of the method for manufacturing a fibrous paper-plastic disc-shaped product of the present invention, the hot-press machine has the features of fast hot-press molding and short working hour, so that the production cycle is much less than that of the conventional method for manufacturing a molded product. Therefore, the present invention can produce more products within the same time. The production capacity is increased, the production cycle is shortened, the productivity is improved, and the production cost is lowered significantly.

Improving the quality and strength of the product: The method for manufacturing a fibrous paper-plastic disc-shaped product of the present invention directly uses the pulp sheets as the manufacturing material without adding other fillers, so that the finished product has a higher fiber density, a better quality, a greater strength per unit product where are more than twice of the conventional method for manufacturing the molded product.

In summation of the above description, the present invention herein enhances the performance than the conventional structure and further complies with the patent application requirements and is submitted for patent application. While the invention has been described by means of specific embodiments, numerous modifications and variations could be made thereto by those skilled in the art without departing from the scope and spirit of the invention set forth in the claims.

What is claimed is:

1. A method for manufacturing a fibrous paper-plastic disc-shaped product, comprising the steps of:
(1) conveying a flat flaky pulp sheet to a cutting machine to cut the pulp sheet into a primitive sheet, wherein the primitive sheet is formed by at least one primitive material for manufacturing a desired fibrous product;
(2) coating a solution containing an additive onto a surface of the primitive sheet;
(3) sending the primitive sheet processed with the coating to a hot-press machine, and heating and pressurizing the primitive sheet by the hot-press machine, so that the primitive sheet is pressed and dried into a dry molded plate, and each original primitive material is pressed into a shape of the desired fibrous product to form a dry molded product; and
(4) sending the dry molded plate to a trimming machine for trimming and cutting the dry molded plate according to the size of the fibrous product, so as to form the fibrous product from the original dry molded product.

2. The method for manufacturing a fibrous paper-plastic disc-shaped product according to claim 1, wherein the primitive sheet processed with the coating is set still, so that the solution received by the primitive sheet is further mixed and permeated into the primitive sheet uniformly to achieve an osmotic balance effect, and then the primitive sheet processed with the static balance is sent to the hot-press machine.

3. The method for manufacturing a fibrous paper-plastic disc-shaped product according to claim 1, wherein the pulp sheet is conveyed by a first conveyor, so that the pulp sheets are entered into the cutting machine sequentially.

4. The method for manufacturing a fibrous paper-plastic disc-shaped product according to claim 1, wherein the primitive sheet processed with the coating is conveyed by a second conveyor.
